(19) United States
(12) Patent Application Publication
(10) Pub. No.: US 2026/0054573 A1
(43) Pub. Date: Feb. 26, 2026

(54) FIXING DEVICE AND VEHICLE EQUIPPED WITH THE SAME

(71) Applicant: HYUNDAI MOBIS CO., LTD., Seoul (KR)

(72) Inventor: Sung Bae Jeon, Yongin-si (KR)

(73) Assignee: HYUNDAI MOBIS CO., LTD., Seoul (KR)

(21) Appl. No.: 19/052,892

(22) Filed: Feb. 13, 2025

(30) Foreign Application Priority Data
Aug. 26, 2024 (KR) 10-2024-0114331

(51) Int. Cl. B60K 35/50

(52) U.S. Cl. CPC B60K 35/50

(57) ABSTRACT

Disclosed is a fixing device including a cover bracket formed to allow an electronic component to be seated thereon, and a coupling portion formed to protrude rearward from a rear surface of the cover bracket, wherein the coupling portion includes a fixing body formed to extend from the rear surface of the cover bracket, a cylindrical coupling protrusion formed to extend from the fixing body, a head formed at one end of the coupling protrusion and including a curved surface, and a rubber member formed to be fitted along the curved surface of the head and to surround an outer circumferential surface of the coupling protrusion. The fixing device reduces quality problems caused by poor processing and assembly by forming a coupling portion for fixing a cover bracket, on which an electronic component such as an AVN set is seated, to a vehicle body integrally with a cover bracket.

### This application claims the benefit of Korean Patent Application No.10-2024-0114331, filed on Aug. 26, 2024, which is hereby incorporated by reference as if fully set forth herein.

### BACKGROUND OF THE DISCLOSURE

### Field of the Disclosure

The present disclosure relates to a fixing device and a vehicle equipped with the same that may reduce quality problems caused by poor processing and assembly by forming a coupling portion for fixing a cover bracket, on which an electronic component such as an AVN set is seated, to a vehicle body integrally with a cover bracket.

### Discussion of the Related Art

In general, a crash pad is disposed in a front portion of vehicle interior, which constitutes a driver's seat and a passenger's seat of the vehicle, and various electrical components, a dash panel, an air conditioning (HVAC) device, and the like required for driving are mounted thereon.

A cowl crossbar is installed in a left and right direction of the crash pad, and the various electrical components, devices, and the like are fixed to the cowl crossbar. A pre-assembled crash pad, cowl crossbar, various electrical components, and the like are called a cockpit module.

An AVN set for the vehicle is embedded and installed in a center fascia at a central portion of the cockpit module located between the driver's seat and the passenger's seat. Such AVN set for the vehicle is a box-shaped component equipped with audio, video, and navigation functions.

To secure convenience of a driver, such AVN system provides a TV broadcast while the vehicle is moving or displays map information or the like by introducing a navigation system, thereby providing more convenience to the driver.

Generally, the AVN set for the vehicle, as a rectangular box shape, is embedded in and fixed to the vehicle body via a cover member formed such that the AVN set is seated thereon. In this regard, to fix the cover member to the vehicle body, a structure for fixing the cover member to the vehicle body is required at the rear of the cover member.

Such fixing member generally includes separate screw and bolt. Further, via screw coupling using the bolt and the screw, the cover member on which the AVN set is seated is fixed to the vehicle body. Additionally, for stable coupling of the cover member and the screw, additional work such as bonding using an additional adhesive is required.

However, as the number of components increases, quality problems caused by poor processing and assembly may occur. Furthermore, this may directly lead to an increase in a manufacturing cost.

Therefore, a member to stably fix the electronic component such as the AVN set to the vehicle body, while at the same time solving the above-described problems and simplifying the processing and the assembly is required.

### SUMMARY OF THE DISCLOSURE

The present disclosure is to provide a fixing device and a vehicle equipped with the same, and more specifically, is to provide a fixing device and a vehicle equipped with the same that may reduce quality problems caused by poor processing and assembly by forming a coupling portion for fixing a cover bracket, on which an electronic component such as an AVN set is seated, to a vehicle body integrally with a cover bracket.

In addition, the preset disclosure is to provide a fixing device and a vehicle equipped with the same that may stably fix a cover bracket to a vehicle body via a coupling protrusion and a rubber member formed to surround an outer circumferential surface of the coupling protrusion by being fitted onto the coupling protrusion.

In addition, the preset disclosure is to provide a fixing device and a vehicle equipped with the same that may stably fix a cover bracket to a vehicle body by preventing a movement of a rubber member by allowing fitting grooves of the rubber member to correspond to a plurality of fitting ribs formed to be spaced apart from each other on an outer circumferential surface of a coupling protrusion.

The problem to be solved by the present disclosure is not limited to the above, and other problems not mentioned will be clearly understood by those skilled in the art to which the present disclosure belongs from the description below.

Provided is a fixing device including a cover bracket formed to allow an electronic component to be seated thereon, and a coupling portion formed to protrude rearward from a rear surface of the cover bracket, wherein the coupling portion includes a fixing body formed to extend from the rear surface of the cover bracket, a cylindrical coupling protrusion formed to extend from the fixing body, a head formed at one end of the coupling protrusion and including a curved surface, and a rubber member formed to be fitted along the curved surface of the head and to surround an outer circumferential surface of the coupling protrusion.

The coupling protrusion may include a plurality of fitting ribs formed to be spaced apart from each other on the outer circumferential surface thereof, and the rubber member may include a plurality of fitting grooves defined therein corresponding to the plurality of fitting ribs.

The plurality of fitting ribs may be formed to extend in a longitudinal direction of the coupling protrusion.

The coupling protrusion may include a step defined to be recessed at the one end, and the rubber member may include a catch protrusion formed on an inner circumferential surface thereof and inserted into the step.

A diameter of the head may be greater than a diameter of the coupling protrusion

The fixing body may have a cylindrical shape, and a diameter of the fixing body may be greater than a diameter of the coupling protrusion.

The fixing body may extend from the rear surface of the cover bracket and include a plurality of fixing ribs formed to be spaced apart from each other on an outer circumferential surface thereof.

The plurality of fixing ribs may be formed to extend in a longitudinal direction of the fixing body.

The rubber member may include at least one material selected from a group consisting of silicone, urethane, and thermoplastic elastomer (TPE).

Provided is a vehicle including a vehicle body, and a fixing device that fixes an electronic component to the vehicle body, the fixing device includes a cover bracket formed to allow the electronic component to be seated thereon, and a coupling portion formed to protrude rearward from a rear surface of the cover bracket, and the coupling portion includes a fixing body formed to extend from the rear surface of the cover bracket, a cylindrical coupling protrusion formed to extend from the fixing body, a head formed at one end of the coupling protrusion and including a curved surface, and a rubber member formed to be fitted along the curved surface of the head and to surround an outer circumferential surface of the coupling protrusion.

The fixing device and the vehicle equipped with the same according to the present disclosure may reduce the quality problems caused by the poor processing and assembly by forming the coupling portion for fixing the cover bracket, on which the electronic component such as the AVN set is seated, to the vehicle body integrally with the cover bracket.

In addition, the cover bracket may be stably fixed to the vehicle body via the coupling protrusion and the rubber member formed to surround the outer circumferential surface of the coupling protrusion by being fitted onto the coupling protrusion.

In addition, the cover bracket may be stably fixed to the vehicle body by preventing the movement of the rubber member by allowing the fitting grooves of the rubber member to correspond to the plurality of fitting ribs formed to be spaced apart from each other on the outer circumferential surface of the coupling protrusion.

Effects obtainable from the present disclosure are not limited to the effects mentioned above, and other effects not mentioned will be clearly understood by those skilled in the art from the description below.

### BRIEF DESCRIPTION OF THE DRAWINGS

FIG. 1 is a view for illustrating a general structure for fixing an AVN set to a vehicle body.

FIG. 2 is an A-A cross-sectional view of FIG. 1.

FIG. 3 is a perspective view of a fixing device according to an embodiment of the present disclosure.

FIG. 4 is an enlarged view of an area B in FIG. 3.

FIG. 5 is a view for illustrating a rubber member fitted onto a coupling protrusion in a fixing device according to an embodiment of the present disclosure.

FIG. 6 is a front view of a rubber member fitted onto a coupling protrusion in a fixing device according to an embodiment of the present disclosure.

FIG. 7 is a side view of a coupling protrusion in a fixing device according to an embodiment of the present disclosure.

FIG. 8 is a cross-sectional view for illustrating a catch protrusion of a rubber member inserted into a step defined at one end of a coupling protrusion in a fixing device according to an embodiment of the present disclosure.

### DETAILED DESCRIPTION OF THE DISCLOSURE

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

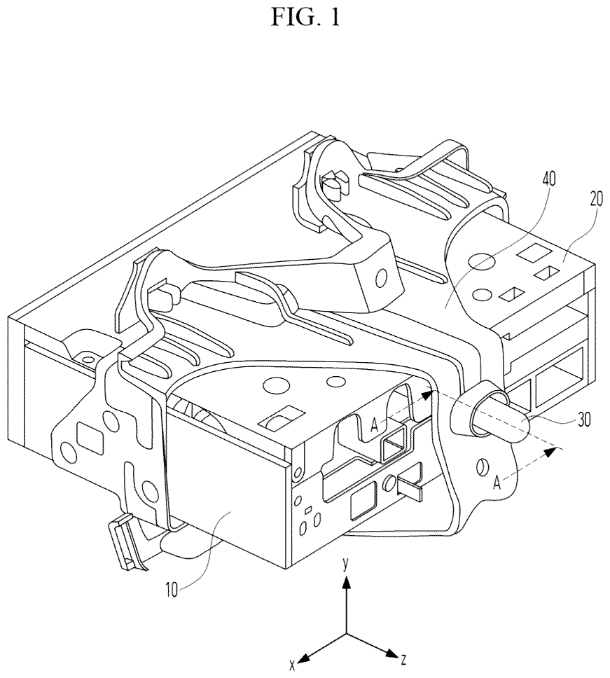

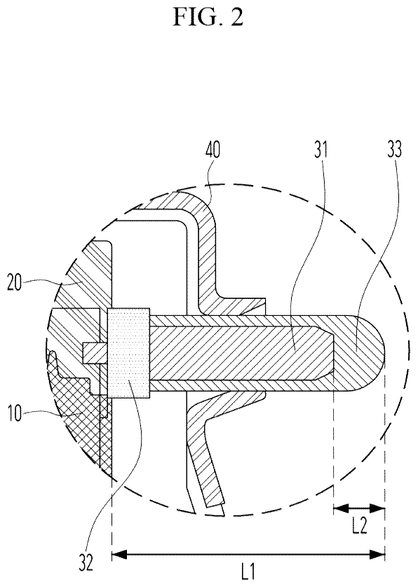

FIG. 1 is a view for illustrating a general structure for fixing an AVN set to a vehicle body. Further, FIG. 2 is an A-A cross-sectional view of FIG. 1.

As described above, a crash pad is generally disposed in a front portion of vehicle interior, which constitutes a driver's seat and a passenger's seat, and various electrical components, a dash panel, an air conditioning (HVAC) device, and the like required for driving are mounted thereon.

A cowl crossbar is installed in a left and right direction of the crash pad, and the various electrical components, devices, and the like are fixed to the cowl crossbar. A pre-assembled crash pad, cowl crossbar, various electrical components, and the like are called a cockpit module.

An AVN set 10 for the vehicle is embedded and installed in a center fascia at a central portion of the cockpit module located between the driver's seat and the passenger's seat. Such AVN set 10 for the vehicle is a box-shaped component equipped with audio, video, and navigation functions.

To secure convenience of a driver, such AVN system provides a TV broadcast while the vehicle is moving or displays map information or the like by introducing a navigation system, thereby providing more convenience to the driver.

Generally, the AVN set 10 for the vehicle, as a rectangular box shape as shown in FIG. 1, is embedded in and fixed to the vehicle body via a cover member 20 formed such that the AVN set 10 is seated thereon. In this regard, to fix the cover member 20 to the vehicle body, a structure for fixing the cover member 20 to the vehicle body is required at the rear (a z-axis direction) of the cover member 20.

Referring to FIG. 2, such fixing member 30 generally includes separate screw 31 and bolt 32. That is, the screw 31 extends through a rear surface of the cover member 20, and the bolt 32 is fastened to fix the screw 31 to the rear surface of the cover member 20. Further, via screw coupling using the screw 31, the cover member 20 on which the AVN set 10 is seated is fixed to the vehicle body.

Additionally, to couple the screw 31 to the rear surface of the cover member 20, additional work such as bonding using an additional adhesive is required. In addition, to fix a fastening member 40, which is for fixing the cover member 20 to the vehicle body, to the cover member 20, rubber 33 is coupled to the screw 31.

In general, the screw 31 and the rubber 33 are formed via double injection. Because of limitations of such process, the rubber 33 protrudes from one end of the screw 31 by a length of L2. As a result, a length L1 of the rubber 33 surrounding the screw 31 has no choice but to be greater than the length of the screw 31 by L2. In addition, the length of L2 becomes an unnecessary length when fixing the cover member 20, on which the AVN set 10 is seated, to the vehicle body.

In addition, as described above, as the number of components for fixing the cover member 20 on which the AVN set 10 is seated increases, quality problems caused by poor processing and assembly may occur. Furthermore, this may directly lead to an increase in a manufacturing cost.

Therefore, the present disclosure aims to stably fix the electronic component such as the AVN set to the vehicle body, while at the same time solving the above-described problems and simplifying the processing and the assembly. This will be described in more detail below.

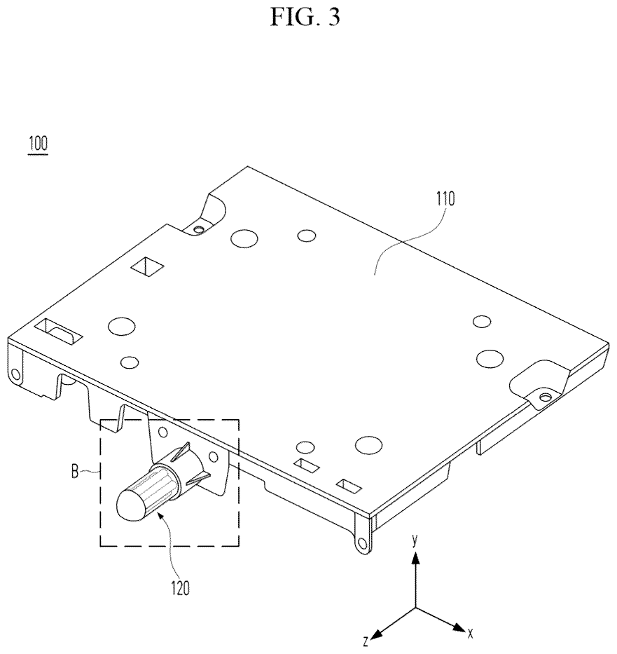

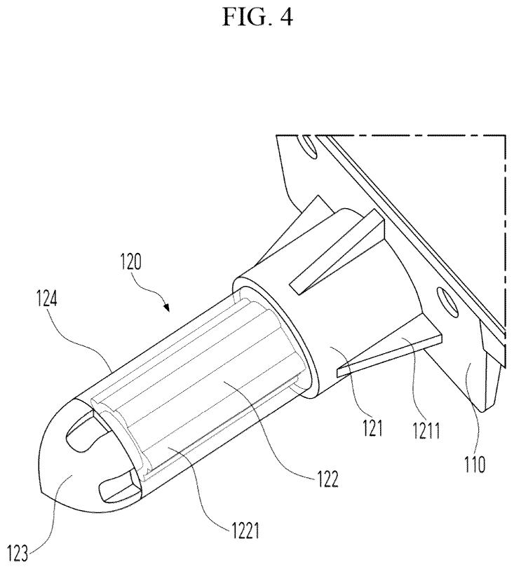

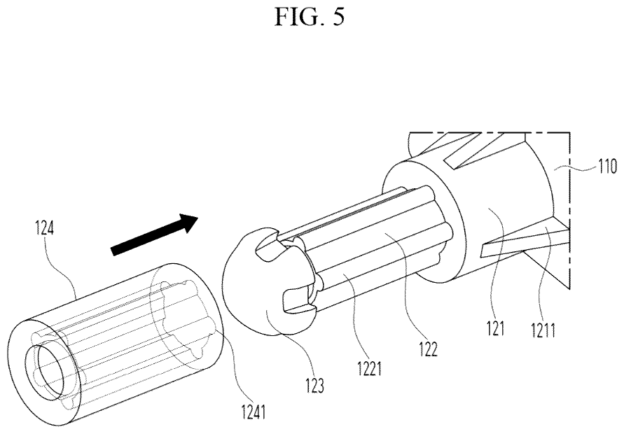

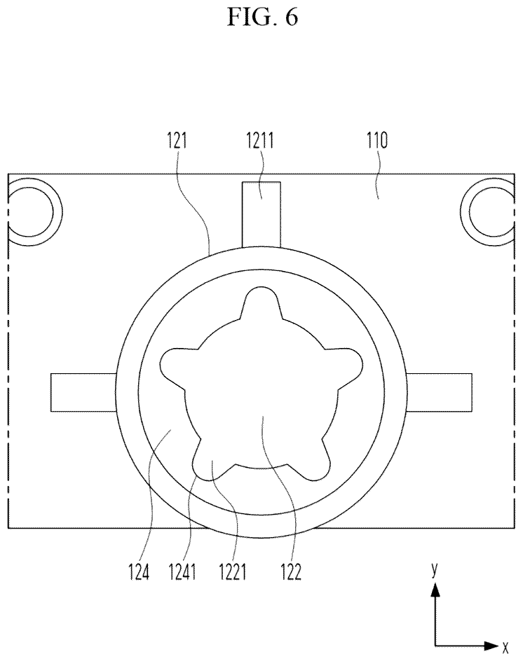

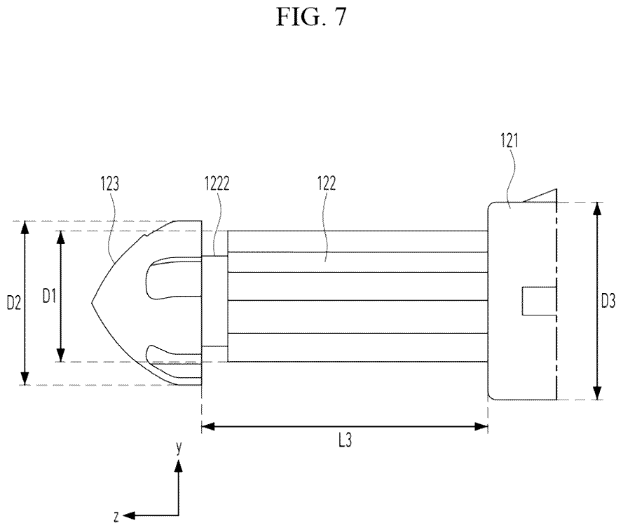

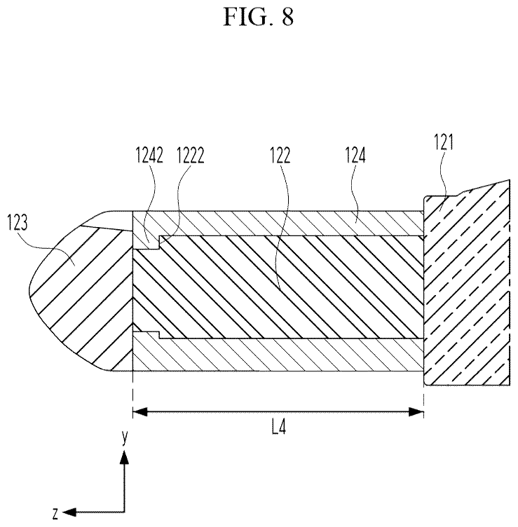

FIG. 3 is a perspective view of a fixing device 100 according to an embodiment of the present disclosure. FIG. 4 is an enlarged view of an area B in FIG. 3. FIG. 5 is a view for illustrating a rubber member 124 fitted onto a coupling protrusion 122 in the fixing device 100 according to an embodiment of the present disclosure. FIG. 6 is a front view of the rubber member 124 fitted onto the coupling protrusion 122 in the fixing device 100 according to an embodiment of the present disclosure. FIG. 7 is a side view of the coupling protrusion 122 in the fixing device 100 according to an embodiment of the present disclosure. Further, FIG. 8 is a cross-sectional view for illustrating a catch protrusion 1241 of the rubber member 124 inserted into a step 1222 defined at one end of the coupling protrusion 122 in the fixing device 100 according to an embodiment of the present disclosure.

Hereinafter, in describing the fixing device 100 according to an embodiment of the present disclosure, the description will be made based on a left and right direction being an x-axis direction, a vertical direction being a y-axis direction, and a front and rear direction being a z-axis direction.

The fixing device 100 according to an embodiment of the present disclosure may serve to fix the electronic component such as the AVN set to the vehicle body. More specifically, the fixing device 100 according to an embodiment of the present disclosure may include a cover bracket 110 and a coupling portion 120 formed by protruding rearward (in the z-axis direction) from a rear surface of the cover bracket 110.

Referring to FIGS. 1 and 3 together, in the fixing device 100 according to an embodiment of the present disclosure, the cover bracket 110 may be formed such that the box-shaped AVN set 10 is seated thereon as described above. In addition, the cover bracket 110 may have a shape to cover a top surface of the AVN set 10 described above and to be coupled with a side surface of the AVN set 10.

For example, in the fixing device 100 according to an embodiment of the present disclosure, the cover bracket 110 may include a shape formed such that a top surface is constructed as a plane as illustrated in FIG. 3 and the top surface is vertically bent at an edge so as to be coupled with the side surface of the AVN set 10 described above via FIG. 1.

In particular, the fixing device 100 according to an embodiment of the present disclosure may include the coupling portion 120 formed so as to protrude rearward (in the z-axis direction) from the rear surface of the cover bracket 110. In this regard, the coupling portion 120 may be formed integrally with the cover bracket 110. This is to simplify the processing and the assembly as described above, thereby reducing quality problems caused by the poor processing and assembly.

More specifically, referring to FIG. 4 together, in the fixing device 100 according to an embodiment of the present disclosure, the coupling portion 120 may include a fixing body 121, the coupling protrusion 122, a head 123, and the rubber member 124. The fixing body 121 may be formed by extending from the rear surface of the cover bracket 110 and may serve to support the coupling protrusion 122.

The coupling protrusion 122 may be formed by extending from the fixing body 121, and may have a cylindrical shape. In addition, the head 123 may be formed at one end of the coupling protrusion 122, and may include a curved surface. With such structure, the rubber member 124 may be fitted along the curved surface of the head 123, as illustrated in FIG. 5. In addition, the rubber member 124 may be formed to surround an outer circumferential surface of the coupling protrusion 122, as illustrated in FIG. 4.

In this regard, the head 123 may serve to allow the rubber member 124 to be fitted. Accordingly, the head 123 may include the curved surface, and may have a shape that converges toward a center of the head 123 rearward (in the z-axis direction), such as a hemispherical shape or a dome shape.

In addition, referring to FIGS. 4 to 6 together, in the fixing device 100 according to an embodiment of the present disclosure, the coupling protrusion 122 may include a plurality of fitting ribs 1221 formed to be spaced apart from each other on the outer circumferential surface thereof. Further, the rubber member 124 may include a plurality of fitting grooves 1241 defined therein so as to correspond to the plurality of fitting ribs 1221.

Additionally, the plurality of fitting ribs 1221 may be formed to extend in a longitudinal direction of the coupling protrusion 122 (the z-axis direction), and as described above, the plurality of fitting grooves 1241 may be defined in a shape corresponding to the plurality of fitting ribs 1221.

Further, accordingly, when the rubber member 124 is fitted onto the coupling protrusion 122 and formed to surround the outer circumferential surface of the coupling protrusion 122, a movement of the rubber member 124 may be prevented. That is, as illustrated in FIG. 6, by fitting the plurality of fitting grooves 1241 into the plurality of fitting ribs 1221, the rubber member 124 may be prevented from rotating on the cylindrical coupling protrusion 122.

This is to ensure that the fastening member 40 for fixing the cover bracket 110 described above with FIG. 1 to the vehicle body is stably fixed to the cover bracket 110 via the rubber member 124. In addition, by fixing the fastening member 40 to the cover bracket 110 via the rubber member 124, the fixing device 100 according to an embodiment of the present disclosure may be stably fixed to the vehicle body.

Furthermore, referring to FIGS. 7 and 8 together, in the fixing device 100 according to an embodiment of the present disclosure, the coupling protrusion 122 may include the step 1222 that is defined to be recessed at one end thereof. Further, the rubber member 124 may include the catch protrusion 1241 formed on an inner circumferential surface thereof and inserted into the step 1222.

Accordingly, when the rubber member 124 is formed to be fitted onto the coupling protrusion 122 and to surround the outer circumferential surface of the coupling protrusion 122, the movement of the rubber member 124 may be prevented. That is, as illustrated in FIG. 8, as the catch protrusion 1241 is inserted into the step 1222, the rubber member 124 may be prevented from moving in the front and rear direction (the z-axis direction).

In this regard, the rubber member 124 may serve to stably fix the cover bracket 110 to the vehicle body as described above. Further, the rubber member 124 according to an embodiment of the present disclosure may include at least one material among silicone, urethane, and thermoplastic elastomer (TPE).

In addition, referring to FIGS. 7 and 8 together, in the fixing device 100 according to an embodiment of the present disclosure, a diameter D2 of the head 123 may be greater than a diameter D1 of the coupling protrusion 122. As the diameter D2 of the head 123 is greater than the diameter D1 of the coupling protrusion 122, the rubber member 124 may be prevented from moving in the front and rear direction (the z-axis direction). That is, the head 123 may serve to fix the one end of the rubber member 124.

In addition, in the fixing device 100 according to an embodiment of the present disclosure, the fixing body 121 may have the cylindrical shape, and a diameter D3 of the fixing body 121 may be greater than the diameter D1 of the coupling protrusion 122. As the diameter D3 of the fixing body 121 is greater than the diameter D1 of the coupling protrusion 122, the rubber member 124 may be prevented from moving in the front and rear direction (the z-axis). That is, the fixing body 121 may serve to fix a remaining end of the rubber member 124.

Referring again to FIGS. 4 and 5 together, in the fixing device 100 according to an embodiment of the present disclosure, the fixing body may have the cylindrical shape, and the fixing body may extend from the rear surface of the cover bracket 110 and may include a plurality of fixing ribs 1211 formed to be spaced apart from each other on an outer circumferential surface thereof.

Further, via the plurality of fixing ribs 1211, structural rigidity may be secured when forming the coupling portion 120 integrally with the cover bracket 110. Additionally, the plurality of fixing ribs 1211 may be formed to extend in a longitudinal direction of the fixing body 121 (the z-axis direction). Accordingly, when forming the coupling portion 120 integrally with the cover bracket 110, it may be more advantageous in securing the structural rigidity as described above.

Furthermore, in the fixing device 100 according to an embodiment of the present disclosure, a length L3 of the coupling protrusion 122 illustrated in FIG. 7 and a length L4 of the rubber member 124 illustrated in FIG. 8 are equal to each other. This may be effective in reducing the quality problems caused by the poor processing and assembly, compared to the case in which the rubber 33 protrudes from the one end of the screw 31 by the length of L2 because of the limitation of the double injection process described above with FIG. 2. In addition, the manufacturing cost may be reduced.

In summary, the fixing device according to the present disclosure and the vehicle equipped with the same may reduce the quality problems caused by the poor processing and assembly by forming the coupling portion for fixing the cover bracket, on which the electronic component such as the AVN set is seated, to the vehicle body integrally with the cover bracket. In addition, the cover bracket may be stably fixed to the vehicle body via the coupling protrusion and the rubber member formed to surround the outer circumferential surface of the coupling protrusion by being fitted onto the coupling protrusion. In addition, the fitting grooves of the rubber member may correspond to the plurality of fitting ribs formed to be spaced apart from each other on the outer circumferential surface of the coupling protrusion to prevent the movement of the rubber member, thereby stably fixing the cover bracket to the vehicle body.

The above detailed description is to be construed in all aspects as illustrative and not restrictive. The scope of the present disclosure should be determined by reasonable interpretation of the appended claims and all changes coming within the equivalency range of the present disclosure are intended to be embraced in the scope of the present disclosure.

What is claimed is:

1. A fixing device comprising:
a cover bracket configured to allow an electronic component to be seated thereon; and
a coupling portion protruding rearward from a rear surface of the cover bracket,
wherein the coupling portion includes:
a fixing body extending from the rear surface of the cover bracket;
a cylindrical coupling protrusion extending from the fixing body;
a head positioned at one end of the cylindrical coupling protrusion and including a curved surface; and
a rubber member configured to be fitted along the curved surface of the head and to surround an outer circumferential surface of the cylindrical coupling protrusion.

2. The fixing device of claim 1, wherein the cylindrical coupling protrusion includes a plurality of fitting ribs positioned to be spaced apart from each other on the outer circumferential surface thereof,
wherein the rubber member includes a plurality of fitting grooves defined therein corresponding to the plurality of fitting ribs.

3. The fixing device of claim 2, wherein the plurality of fitting ribs are configured to extend in a longitudinal direction of the cylindrical coupling protrusion.

4. The fixing device of claim 1, wherein the cylindrical coupling protrusion includes a step defined to be recessed at the one end,
wherein the rubber member includes a catch protrusion positioned on an inner circumferential surface thereof and inserted into the step.

5. The fixing device of claim 1, wherein a diameter of the head is greater than a diameter of the cylindrical coupling protrusion.

6. The fixing device of claim 1, wherein the fixing body has a cylindrical shape,
wherein a diameter of the fixing body is greater than a diameter of the cylindrical coupling protrusion.

7. The fixing device of claim 6, wherein the fixing body extends from the rear surface of the cover bracket and includes a plurality of fixing ribs positioned to be spaced apart from each other on an outer circumferential surface thereof.

8. The fixing device of claim 7, wherein the plurality of fixing ribs are configured to extend in a longitudinal direction of the fixing body.

9. The fixing device of claim 1, wherein the rubber member includes at least one material selected from a group consisting of silicone, urethane, and thermoplastic elastomer (TPE).

10. A vehicle comprising:
a vehicle body; and
a fixing device configured to fix an electronic component to the vehicle body,
wherein the fixing device includes:
a cover bracket configured to allow the electronic component to be seated thereon; and
a coupling portion protruding rearward from a rear surface of the cover bracket,
wherein the coupling portion includes:
a fixing body extending from the rear surface of the cover bracket;
a cylindrical coupling protrusion extending from the fixing body;
a head positioned at one end of the cylindrical coupling protrusion and including a curved surface; and
a rubber member configured to be fitted along the curved surface of the head and to surround an outer circumferential surface of the cylindrical coupling protrusion.
